(19) United States
(12) Patent Application Publication
(10) Pub. No.: US 2007/0025589 A1
(43) Pub. Date: Feb. 1, 2007

(54) Image processing apparatus

(75) Inventors: Yuji Okamoto, Souraku-gun (JP); Shuhji Fujii, Souraku-gun (JP); Toshihiro Yamanaka, Ikoma-shi (JP); Syouichirou Yoshiura, Ikoma-gun (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 10/570,038

(22) PCT Filed: Aug. 25, 2004
(86) PCT No.: PCT/JP04/12201

§ 371 Date: Feb. 27, 2006

(30) Foreign Application Priority Data
Aug. 27, 2003 (JP) 2003-303625

(51) Int. Cl. G06K 9/00

(52) U.S. Cl. 382/100

(57) ABSTRACT

An image processing apparatus, such as a digital multiple function processing machine, capable of preventing degradation of security, while storing image data after an output process based on the image data so as to improve convenience. The image processing apparatus selects one of image data concealment methods stored in a first storage part (step S203); conceals image data by use of the selected concealment method (authentication information setting step S207 or encryption step S212); and nullifies unconcealed image data.

This application is the national phase under 35 U.S.C. 371 of PCT International Application No. PCT/JP2004/012201 which has an International filing date of Aug. 25, 2004 and designated the United States of America.

### TECHNICAL FIELD

The present invention relates to an image processing apparatus such as a copying apparatus, printing apparatus, facsimile apparatus, and digital multifunctional product (digital multifunctional printer, digital multifunctional peripheral, or MFP) which includes two or more functions of these apparatuses, which includes storing means for storing image data and perform output processes based on the image data stored in the storing means, especially to an image processing apparatus which prevents image data leakage.

### BACKGROUND ART

Conventionally, a digital multifunctional product (digital multifunctional printer, digital multifunctional peripheral, or MFP) as image processing apparatuses is commodified which includes two or more functions such as functions of a copying apparatus which scans images formed on documents, captures the images as image data, forms and outputs images based on the captured image data, functions of a facsimile apparatus which transmits and receives image data to/from outward facsimile apparatuses using facsimile communication, a transmit function for transmits the captured image data to outward apparatuses, and functions of a printing apparatus which accepts image data transmitted from outward apparatuses and forms images on image forming media such as copying paper sheets based on the accepted image data. Especially, a recent digital multifunctional product includes storing means such as a hard drive for storing image data and achieves parallel processing of these functions.

Various new functions for the above-mentioned digital multifunctional products are proposed such as electronic filing functions in which image data are stored in storing means, and an image based on the stored image data is formed and output on an image forming media such as a copying paper sheet as needed, and image server functions in which image data are transmitted to communication apparatuses such as a personal computer connected outwardly. As an example, in Patent Document 1, an image data output controlling apparatus is disclosed including an electronic filing function in which image data which are captured by a scanner or received with facsimile communication are stored and the stored image data are red out and output as needed. Using such image processing apparatus allows image data used once to be reused and an operator may output documents and images as needed.

Image data processed by an image processing apparatus can include the image data with confidentiality such as documents recording trade secrets, and when unrestricted storing and output of image data are allowed, security problems such as leakage of information and unfair use of information may arise. Therefore, Patent Document 2 discloses a copying apparatus performing authentication before use and permitting use only to operators who have been registered in advance. Patent Document 3 discloses a copying apparatus which embeds specific information into an image to be output and when outward leakage of the output image takes place, is able to trace a route of the leakage.

Moreover, Patent Document 4 discloses a technology for encrypting image data and storing them in storing means, as a security measure on image data stored by the image processing apparatus. Patent Document 5 discloses a technology for deleting stored image data at a stage when it is not needed. In the case that the image processing apparatus has such a nullification function of image data wherein encryption or deletion of the image data is performed, it is difficult to take out the image data from the image processing apparatus and to use them unfairly, and therefore security of the image processing apparatus is improved.
[Patent Document 1] Japanese Patent Application Laid-Open No. 06-178041
[Patent Document 2] Japanese Patent Application Laid-Open No. 07-28365
[Patent Document 3] Japanese Patent Application Laid-Open No. 2000-187419
[Patent Document 4] Japanese Patent Application Laid-Open No. 01-256068
[Patent Document 5] Japanese Patent Application Laid-Open No. 09-223061

### DISCLOSURE OF THE INVENTION PROBLEMS TO BE SOLVED BY THE INVENTION

The aforementioned nullification function for nullifying image data is possibly provided as an optional or subsidiary function for the image processing apparatus. However, in the case that the nullification function is attached optionally to the image processing apparatus having the storing function for storing image data, since the nullification function is a contrary function to the storing function, when the nullification function is given a priority over the storing function, convenience of the image processing apparatus is diminished because of limitation of the storing function for storing image data, and when the storing function is given a priority over the nullification function, security of the image processing apparatus is diminished because of limitation of the nullification function for nullifying image data. Thus, problems that the functions of the image processing apparatus cannot function effectively possibly arise.

In view of this situation, the present invention has been developed, and an object of this invention is to provide an image processing apparatus which is capable of making convenience and security compatible and capable of performing functions of the image processing apparatus effectively. By storing only the designated image data out of image data stored in storing means after the designated image data is concealed by means of a concealing method such as encryption and setting authentication information, and by nullifying the undesignated image data, concealing of the image data to be stored and nullifying the undesignated image data are performed, while the convenience of storing function of the image processing apparatus is exploited. Thereby the given object is achieved.

### MEANS FOR SOLVING THE PROBLEMS

An image processing apparatus of this invention including storing means for storing image data and performing an output process based on the image data stored in the storing means, comprises means for designating the image data stored in the storing means and accepting an instruction for concealment of the designated image data, means for concealing the designated image data based on the accepted instruction, and means for nullifying unconcealed image data.

The image processing apparatus of this invention further comprises means for detecting whether or not processing means for processing the image data is provided and an operation state thereof and means for determining a concealing method based on detected results.

An image processing apparatus of this invention including storing means for storing image data and performing an output operation based on the image data stored in the storing means, comprises means for designating the image data stored in the storing means and accepting an instruction for concealment of the designated image data, means for detecting whether or not processing means for processing the image data is provided and an operation state thereof, means for determining a concealing method based on detected results, and means for concealing the designated image data by means of the determined method based on the accepted instruction.

The image processing apparatus of this invention, wherein the concealing method is encrypting the image data, further comprises means for decoding encrypted image data in the case of performing an output operation based on the image data.

The image processing apparatus of this invention, wherein the concealing method is setting of authentication information to the image data, further comprises means for accepting authentication information, means for verifying the authentication information set to the image data with the accepted authentication information, and means for permitting the output process of the image data in the case where the authentication information set to the image data matches the accepted authentication information.

### EFFECTS OF THE INVENTION

The image processing apparatus of the present invention gives a superior effect of improving convenience of the output process, maintaining security, because the designated image data is stored, being concealed. In the case of designating the image data stored in the storing means and accepting an instruction for concealment of the designated image data, the designated image data is concealed based on the accepted instruction and unconcealed image data is nullified. Thus, possibility of the leakage of information can be significantly diminished because of the nullification, such as overwriting meaningless data, of the undesignated image data.

The concealing method is determined based on whether or not the processing means, which is mounted for an optional function, is provided and an operation state of the processing means. For example, when the processing means is means for encrypting the image data in storing the image data, the concealing method may become, for example, setting authentication information which is different from the encryption. Thus, the image processing apparatus gives another superior effect that secrecy can be improved by effectively using the optional function, if it is provided and active, and that load of the operation of concealing can be relieved because the operation of the processing means is performed separately from the operation of concealing.

The image processing apparatus gives another superior effect that convenience of the output process can be improved, because the designated image data is stored in concealment and the output process can be performed as needed, while maintaining security. In the case of designating the image data stored in the storing means and accepting an instruction for concealment of the designated image data, the designated image data is concealed based on the accepted instruction and the concealing method is determined based on whether or not the processing means, which is mounted for an optional function, is provided and an operation state of the processing means. Moreover, for example, when the processing means is means for encrypting the image data in storing the image data, the concealing method may be, for example, setting the authentication information which is different from the encryption. Thus, the effective use of the optional function, if it is provided, can improve secrecy, and load of the operation of concealing can be relieved because of the operation can be shared with the processing means.

The image processing apparatus gives another superior effect that convenience and security are compatibly achieved by storing image data after encryption as the concealing method and the output process of the image data after decryption as needed.

The image processing apparatus gives another superior effect that convenience and security are compatibly achieved by storing image data after setting the authentication information, a so-called password, as the concealing method and performing the output process of the image data after verifying the authentication information as needed.

### BRIEF DESCRIPTION OF THE DRAWINGS

FIG. 1 is a schematic block diagram showing a structure of an image processing apparatus according to the present invention.

FIG. 2 is a flowchart showing an output process of the image processing apparatus according to the present invention.

FIG. 3(a) to 3(c) are illustrative diagrams showing images displayed on displaying means of an operation unit comprised by the image processing apparatus of the present invention.

FIG. 4 is a flowchart showing an image data moving process of the image processing apparatus according to the present invention.

FIG. 5(a) and 5(b) are illustrative diagrams showing images displayed on the displaying means of the operation unit comprised by the image processing apparatus of the present invention.

FIG. 6 is a flowchart showing an delete process of the image processing apparatus according to the present invention.

FIG. 7 is a flowchart showing an output process of the image processing apparatus according to the present invention.

### DESCRIPTION OF REFERENCE NUMERALS

1 Image Processing Apparatus.
10 Processing Unit.
11 Controlling Unit.
12 Operation Unit.
13 Communication Unit.
14 Management Unit.
15 ROM.
16 Storage Unit.
161 First Storage Unit.
162 Second Storage Unit.
17 Image Reading Unit.
18 Image Memory.
19 Image Forming Unit.
2 Communication Apparatus.

### BEST MODE FOR IMPLEMENTING THE INVENTION

The present invention is illustrated below in detail based on drawings which show embodiments thereof

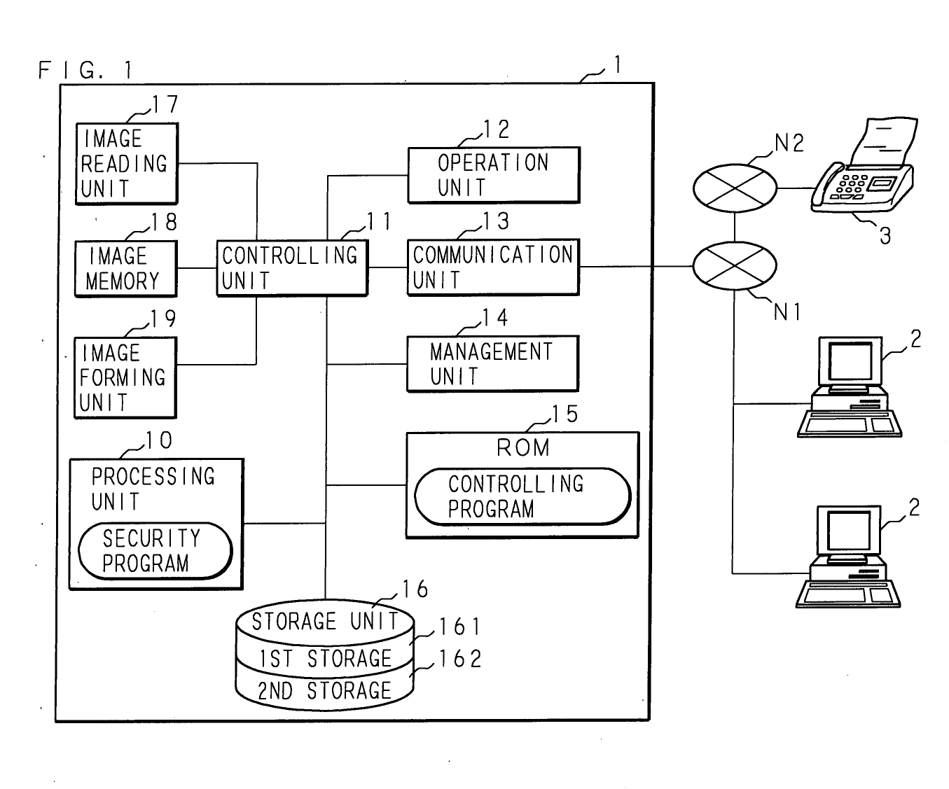

FIG. 1 is a schematic block diagram showing a structure of an image processing apparatus according to this invention.

Reference numeral 1 designates an image processing apparatus such as a copying apparatus performing an output process based on image data, printing apparatus, facsimile apparatus, and digital multifunctional product (digital multifunctional printer, digital multifunctional peripheral, or MFP) including at least two functions of these apparatuses. The image processing apparatus 1 comprises a controlling unit 11 including a CPU performing operations and a RAM storing temporary information accompanying the operations, a ROM 15 storing a controlling program for controlling the image processing apparatus 1 which is connected to the controlling unit 11, and the controlling unit 11 performs whole control of the image processing apparatus 1 in accordance with the controlling program which the ROM 11 stores.

Moreover, a management unit 14 as memory storing information which indicates conditions of the image processing apparatus 1 is connected to the controlling unit 11, and the controlling unit 11 refers to the information stored in the management unit and controls the image processing apparatus 1 based on the information which is referred to. And an image reading unit 17 which reads an image formed on a document by scanning and generates electronic image data based on the read image, image memory 18 storing the image data temporarily and an image forming unit 19 which forms and outputs an image on an image forming media such as a copying paper sheet based on the image data which the image memory 18 stores are connected to the controlling unit 11. The image processing apparatus 1 functions as a copying apparatus by the above-mentioned structure. And a storage unit 16 consisting of hard drives or nonvolatile memory is connected to the controlling unit 11 and stores image data. Further, an operation unit 12 accepting an operation by an operator is connected to the controlling unit 11 and has displaying means such as a liquid crystal panel displaying information required for the operation and an input unit such as a touch panel and a numeric keypad to which information such as a controlling instruction is input by an operation of the operator.

Moreover, a communication unit 13 connected to an external communication network N1 such as a LAN is connected to the controlling unit 11, and transmits and receives information with an external apparatus through the communication network N1. A plurality of communication apparatuses 2, 2, . . . such as personal computers are connected to the communication network N1, the communication unit 13 receives image data transmitted from the communication apparatuses 2, 2, . . . through the communication network N1, and the image forming unit 19 forms and outputs an image based on the image data which the communication unit 13 receives. The image processing apparatus 1 functions as a network printing apparatus by the above-mentioned structure.

Further, the image processing apparatus 1 can transmit image data formed based on an image which the image reading unit 17 reads from the communication unit 13 to the communication apparatus 2 through the communication network N1. The image processing apparatus 1 functions as a network scanning apparatus by the above-mentioned structure.

Moreover, the communication unit 13 can receive image data transmitted from another facsimile apparatus 3 connected to a public network N2 through a facsimile network N2, and the image forming unit 19 can form and output an image based on the image data which the communication unit 13 receives. The image processing apparatus 1 functions as a facsimile apparatus by the above-mentioned structure.

The storage unit 16 includes a storage region of a first storage unit 161 and a second storage unit 162. The first storage unit 161 stores image data corresponding to an image output from the image forming unit 19 as an output history. When it is required again to output the image which has been already output because of an output failure, lack of number of output sheets, etc., the controlling unit 11 reads out a required image data from the first storage unit 16 in accordance with an instruction such as an instruction which the operation unit 12 receives and an instruction which is transmitted from the communication apparatus 2 and is received by the communication unit 13, and the image forming unit 19 forms and outputs an image based on the image data read out. The second storage unit 162 sorts and stores image data by categories such as file formats, processing modes which are copying, facsimile transmission, printing output, etc., and folders made by the operator.

The operator can choose image data which the second storage unit 162 stores by an operation of the operation unit 12 or by transmitting an instruction from the communication apparatus 2, and can use the image data which the second storage unit 162 stores by an output operation such as an output of an image with the image forming unit 19 and transmission of the image data to the outside from the communication unit 13. The image processing apparatus 1 functions as an image data server apparatus by the above-mentioned structure.

A memory capacity of the first storage unit 161 is smaller than a memory capacity of the second storage unit 162, and image data stored in the first storage unit 161 is deleted when satisfying a predetermined condition such as a lack of the memory capacity of the first storage unit 161 and an elapse of a predetermined period after the image data is stored. Image data which the second storage unit 162 stores is stored until the controlling unit 11 receives an instruction for deletion. In the case of lack of the memory capacity of the second storage unit 162, the controlling unit 11 displays information indicating the lack of the capacity, receives an instruction for deletion of unneeded image data, which is input in response to the displayed information, and deletes the image data based on the received instruction.

Various functions of the image processing apparatus 1 mentioned above are realized by means of the controlling unit 11 executing the controlling program which the ROM 15 stores. The image processing apparatus 1 of this invention may be equipped with a processing unit 10 constituted by a circuit storing a security program which performs processing such as encryption of image data, etc. The processing unit 10 equipped to the image processing apparatus 1 may realize reinforced security by means of processing such as automatic encryption of image data stored in the first storage unit 161 and the second storage unit 162. And in place of additional equipment of the processing unit 10, use of the ROM 15 comprising the security program which the processing unit includes allows the ROM 15 to operate as a circuit comprising a function of the processing unit 10 as well, realizing reinforced security. Further, since the management unit 14 stores information indicating whether or not the processing unit 10 is provided and an operation state of the processing unit as management information, whether or not the processing unit 10 is provided and an operation state of the processing unit can be detected as needed.

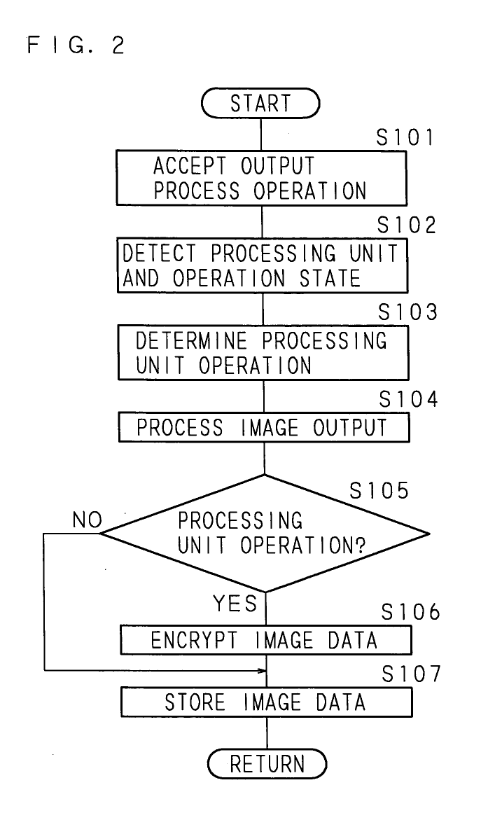

Next, processes of the image processing apparatus 1 of this invention are illustrated. FIG. 2 is a flow chart showing an output process of the image processing apparatus 1 of this invention. When an output process based on image data as, for example, a copying process is needed, an operator who operates the image processing apparatus 1 inputs an operation which allows the output process by operating the operation unit 12 which is included by the image processing apparatus 1. And in place of performing the operation using the operation unit 12, the communication apparatus 2 may be operated to transmit a command indicating the operation, so that the image processing apparatus 1 accepts the operation which the received command indicates.

The image processing apparatus 1 accepts an operation which allows to perform an output process based on image data under the control of the controlling unit 11 which executes the controlling program which the ROM 15 stores (S101), detects whether or not the processing unit is provided and a performing state which are included in management information which the management unit 14 stores (S102), and determine whether or not the processing unit 10 is to be operated, herein whether or not the security program is to be executed, based on a result of the detection (S103).

When the processing unit 10 is equipped and the processing unit 10 is active, it is determined at the step S103 to activate the processing unit 10 and execute the security program, and when the processing unit 10 is not equipped or is not active, it is determined at the step S103 not to activate the processing unit 10. And the image processing apparatus 1 can perform processes the steps S102 to S103 at activation thereof and retain a determined result as initial settings until termination thereof, in stead of determining whether or not the processing unit 10 is to be performed every time the operation which allows to perform the output process is accepted.

Further, the image processing apparatus 1 performs the image output process based on the image data under the control of the controlling unit 11 which executes the controlling program which the ROM 15 stores (S104). In the case of functioning as an apparatus such as a copying apparatus and a facsimile transmitting apparatus, the image data at the step S104 is the image data formed based on the image which the image reading unit 17 reads, and in the case of functioning as an apparatus such as a network printing apparatus and a facsimile receiving apparatus, it is the image data accepted through the communication unit 13. And In the case of functioning as an apparatus such as a copying apparatus and a facsimile receiving apparatus, the image output process is a process which forms and outputs an image on image forming media such as copying paper sheets, and in the case of functioning as an apparatus such as a network printing apparatus and a facsimile transmitting apparatus, it is a process which transmits the image data through the communication unit 13.

Further, the image processing apparatus 1 judges whether or not performance of the processing unit 10, that is, execution of the security program under the control of the controlling unit 11 which executes the controlling program stored by the ROM 15 is determined to be required, at the step S103 (S105), and in the case of judgment of determination that the processing unit 10 is to be performed (S105: YES), the image processing apparatus executes the security program to encrypt the image data after the image output process (S106), and stores the encrypted image data in the first storage unit 161 (S107). At step S105, in case of judgment of determination that the processing unit 10 is not to be performed (S105: NO), proceeding to step S107, the image data after the image output process is stored in the first storage 161 (S107). Alternatively, the image data may be deleted in place of being stored in the first storage unit 161, or stored in the second storage unit 162, in accordance with the setting by the operator.

Next, an image data moving process of the image processing apparatus 1 of this invention is explained hereafter. At the step S107 of the output process of the image processing apparatus 1 illustrated in FIG. 2, the image data stored in the first storage unit 161 is to be removed when satisfying a predetermined condition such as a case of lack of the memory capacity of the first storage unit 161, a case of elapse of a predetermined period after storage, and a case of performance of a predetermined number of storage. Thus, when prevention of deletion of the image data is needed, a moving operation of the image data stored in the first storage unit 161 to the second storage unit 162 is to be performed.

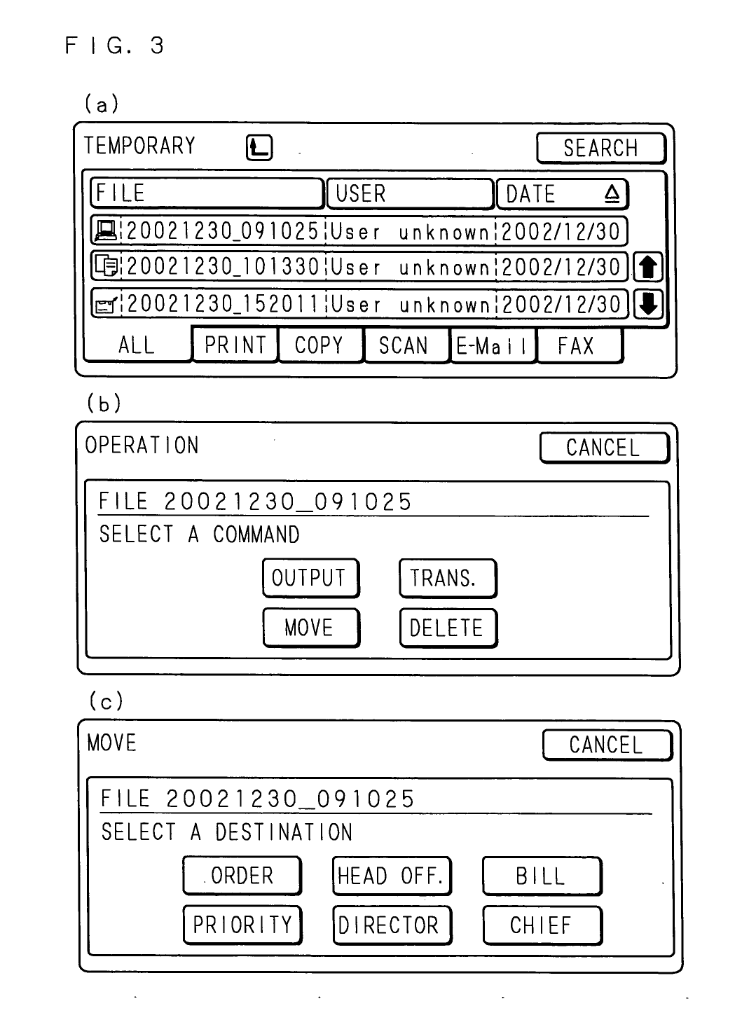

FIG. 3(a) to 3(c) are illustrative diagrams showing images displayed on the displaying means of the operation unit 12 comprised by the image processing apparatus 1 of this invention. FIG. 3(a) shows an image in which a list of image data stored in the first storage unit 161 which the image processing apparatus 1 comprises is displayed. Information such as an icon indicating an output mode of image data such as an output by a copy function and an output by a facsimile function, a file name indicating a name of the image data, a user name indication a source of transmission of the image data, and a date indicating when the image data is stored, etc., are given for each image data. By designating desired image data in the list shown in FIG. 3(a), an image shown in FIG. 3(b) is displayed on the displaying means of the operation unit 12. In FIG. 3(b), a state in which the image data having the file name 20021230_{—}091025 is designated is shown, and icons indicating output, transmit, move and delete operations for the designated image data. Here, by selecting the move operation, an image shown in FIG. 3(c) is displayed on the displaying means of the operation unit 12. In FIG. 3(c), folder names such as “ORDER”, “HEAD OFFICE” and “BILL” set in the second storage unit as a destination are displayed, and by performing an operation of selection of a desired folder, an operation in which the designated image data stored in the first storage unit 161 is moved to the selected folder starts. When the image processing apparatus 1 of this invention moves the image data to the second storage unit 162, the image data is stored as a concealed one in the second storage unit. Thus, an instruction for moving the image data to the second storage unit 162 means an instruction for designating the image data stored in the first storage unit 161 and for concealing the designated image data.

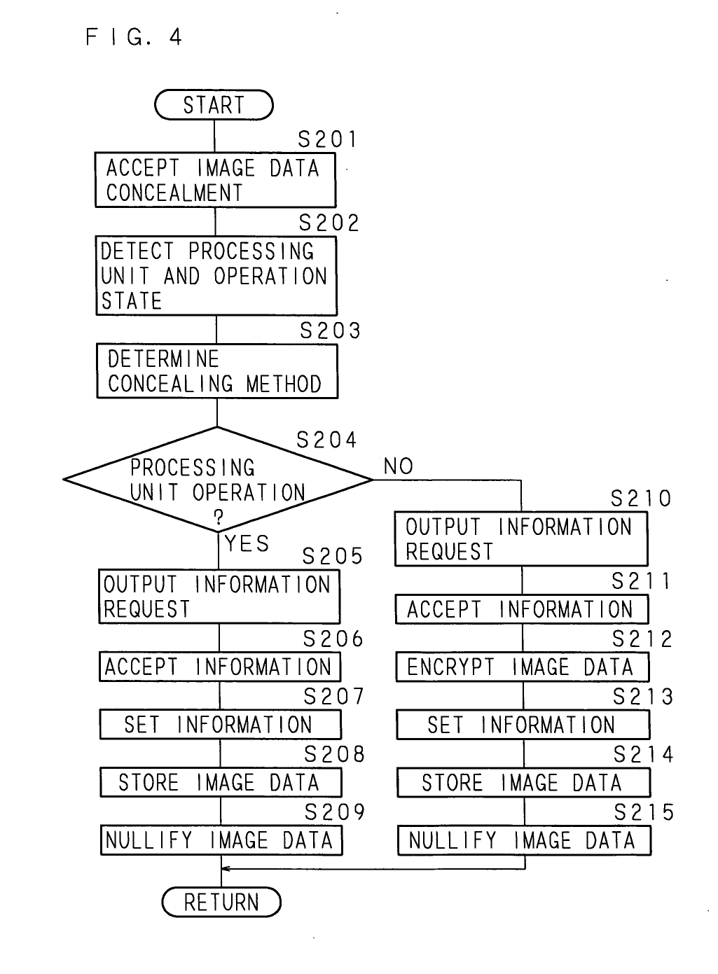

FIG. 4 is a flow chart showing an image data moving process of the image processing apparatus 1 of this invention. The image processing apparatus 1 accepts an instruction of an operation for moving the image data stored in the first storage unit 161 to the second storage unit 162, that is, designating of the image data stored in the first storage unit 161 and concealing the designated image data, from the input unit of the operation unit 12 under the control of the controlling unit 11 which executes the controlling program which the ROM 15 stores (S201), detects whether or not the processing unit is provided and a performing state which are included in management information which the management unit 14 stores (S202), and determines a concealing method of the image data, based on a result of the detection (S203).

At the step S203, when the processing unit 10 is equipped and the processing unit 10 is active, since the image data stored in the first storage unit 161 has been already encrypted, it is decided that the concealing method is to set authentication information, a so-called password, to the image data. When the processing unit 10 is not equipped or is not active, it is decided that the concealing method is to encrypt the image data and to set authentication information. This decision is for one of possible embodiments of this invention, and various decisions for other possible embodiments may be done. For example, when the processing unit 10 is equipped and the processing unit 10 is active, the concealing method may not be set and it may be decided that the image data is to be stored in the second storage unit 162 in an encrypted state as it is stored in the first storage unit 161. And when the processing unit 10 is not equipped or is not active, it may be decided that the concealing method is to encrypt the image data. And the image processing apparatus 1 may perform processes of steps S202 to S203 at activation thereof and retain a determined result as initial settings until termination thereof, instead of determining whether or not the processing unit 10 is to be performed every time the operation which allows to perform the output process is accepted.

The image processing apparatus 1 judges whether or not the performing state detected at step S202 is a state wherein the processing unit 10 is equipped and active (S204), and when it is judged that the processing unit 10 is equipped and active (S204: YES), and the image processing apparatus outputs an authentication information input request requesting input of authentication information so as to conceal the image data by the concealing method decided at step S203, that is, by setting authentication information, under the control of the controlling unit 11 which executes the controlling program which the ROM 15 stores (S205). The authentication information input request at step S205 is an output process such as displaying on the display means of the operation unit 12 and transmitting to the communication apparatus 2.

The operator inputs, for example, from the input means of the operation unit 12, a code string which consists of random combination of codes such as alphabets and digits as authentication information in response to the authentication information input request which is output. The image processing apparatus 1 accepts the authentication information under the control of the controlling unit 11 which executes the controlling program which the ROM 15 stores (S206), sets the accepted authentication information to the image data (S207), stores the image data to which the authentication information is set in the second storage unit 162 (S208), and nullifies the image data stored in the first storage unit 161 (S209).

The nullification at step 208 includes not only a deletion process by which management data stored in FAT is rewritten, but also a process for making recurrence of the image data significantly difficult by repeated overwriting of meaningless data such as data generated using random data and data in which just ones or zeros continue to the image data stored in the first storage unit 161. The authentication information is set to the encrypted image data which is stored in the first storage unit 161, the resulting image data is stored in the second storage unit 162, and the encrypted image data stored in the first storage unit 161 is nullified. Thereby the image data stored in the first storage unit 161 is concealed and moved to the second storage unit 162.

At step S204, in the case that it is judged that the processing unit 10 is not equipped or not active (S204: NO), the image processing apparatus 1 outputs an authentication information input request requesting input of authentication information so as to conceal the image data by the concealing method decided at the step S203, that is, by setting authentication information, under the control of the controlling unit 11 which executes the controlling program which the ROM 15 stores (S210).

The operator inputs authentication information in response to the authentication information input request which is output. The image processing apparatus 1 accepts the authentication information under the control of the controlling unit 11 which executes the controlling program which the ROM 15 stores (S211), encrypts the image data (S212), sets the accepted authentication information to the encrypted image data (S213), stores the image data to which the authentication information is set in the second storage unit 162 (S214), and nullifies the image data stored in the first storage unit 161 (S215). Thus, the authentication information is set to the image data which is stored in the first storage unit 161 after encrypting the image data, and the resulting image data is stored in the second storage unit 162, and the image data stored in the first storage unit 161 is nullified. Thereby the image data stored in the first storage unit 161 is concealed and moved to the second storage unit 162.

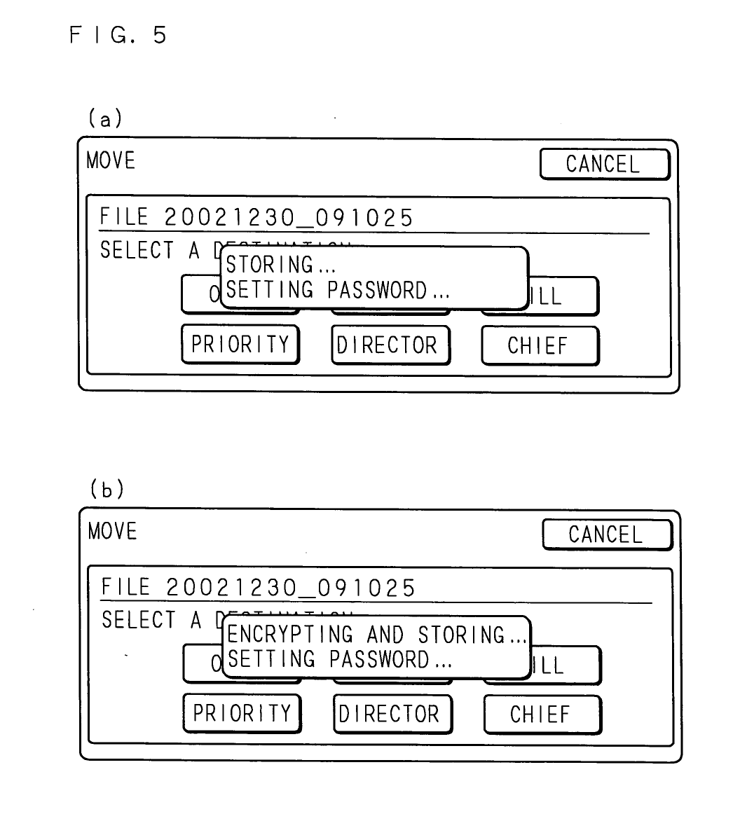

FIG. 5(a) and 5(b) are illustrative diagrams showing images displayed on the displaying means of the operation unit 12 comprised by the image processing apparatus 1 of this invention. FIG. 5(a) and 5(b) show images shown during the process in which the authentication information is set to the image data and the image data is stored. After accepting an operation at the state shown in FIG. 3(c), a state in which the image data is being concealed is displayed as shown in FIG. 5(a) and 5(b). FIG, 5(a) shows an image displayed when a concealing method is to set authentication information to the image data, and FIG. 5(b) shows an image displayed when a concealing method is to encrypt the image data and to set authentication information to the image data.

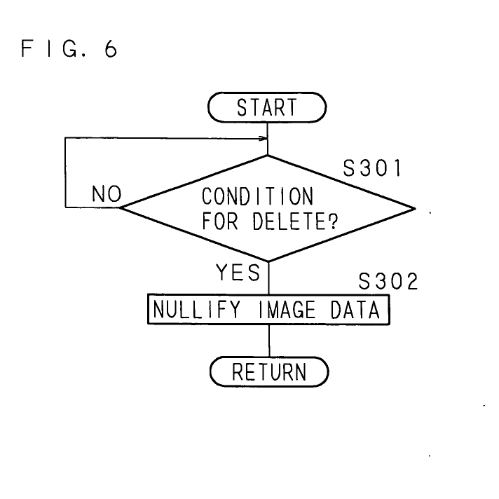

Hereafter a process in which image data stored in the first storage unit 161 is deleted is explained. FIG. 6 is a flow chart showing a delete process of the image processing apparatus 1 of this invention. The image processing apparatus 1 judges at predetermined time intervals whether or not image data stored in the first storage unit 161 satisfies a predetermined condition for deletion (S301). When the predetermined condition of deletion is satisfied (S301: YES), image data which satisfies the condition for deletion is nullified based on the rule of so-called FIFO (First In First Out) in which data items are output in the order that they are input (S302).

The predetermined condition of deletion at step 301 is a condition such as a case of lack of memory capacity of the first storage unit 161, a case of elapse of a predetermined period after the image data is stored, and a case of storage of grater number of image data than a predetermined number. The nullification at the step S302 includes not only a deletion process by which only management data stored in FAT is rewritten, but also a process for making recurrence of the image data significantly difficult by repeated overwriting of meaningless data such as data generated using random numbers and data in which just ones and zeros continue to the image data stored in the first storage unit 161. At step S302, the image data which is stored in the first storage unit 161 and not concealed is nullified. The concealment here is not the encryption in storing in the first storage unit 161, but processes such as the encryption in moving to the second storage unit 162 and setting the authentication information. At step S301, when the predetermined condition of deletion is not satisfied (S301: NO), after a predetermined period of waiting time, returning to step S301, the process is repeated.

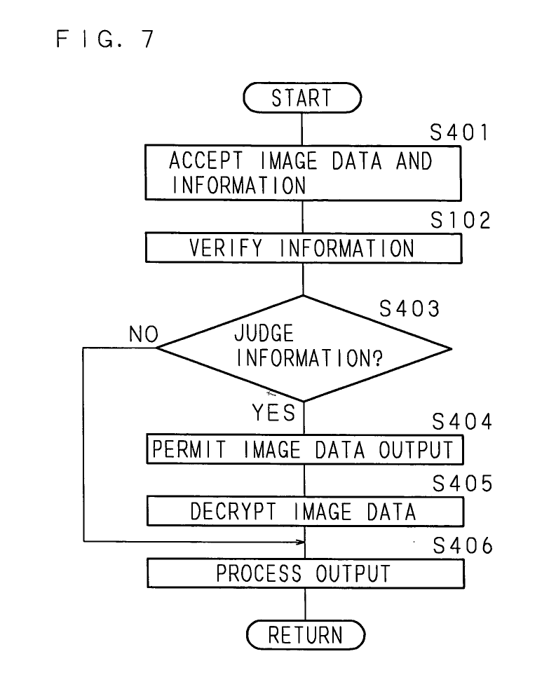

Hereafter an output process for image data stored in the second storage unit 162 is explained. FIG. 7 is a flow chart showing an output process of the image processing apparatus 1 of this invention. When the operator demands an output process based on the concealed image data which is stored in the second storage unit 162, a piece of image data for which the output process is to be performed is designated out of the image data stored in the second storage unit 162, and a process for inputting the authentication information is performed. The image processing apparatus 1 accepts designation of a piece of image data for which the output process is to be performed out of the image data stored in the second storage unit 162 and input of the authentication information, from the input unit of the operation unit 12 under the control of the controlling unit 11 which executes the controlling program which the ROM 15 stores (S401), verifies the accepted authentication information with the authentication information which is set to the designated piece of the image data (S402), and judges whether or not the accepted authentication information matches the authentication information which is set to the piece of the image data (S403).

At step S403, when the accepted authentication information matches the authentication information which is set to the image data (S403: YES), the image processing apparatus 1, under the control of the controlling unit 11 which executes the controlling program which the ROM 15 stores and control of the processing unit 10 which executes the security program, permits the output process of said image data (S404), decrypts said image data which is encrypted (S405), performs the output process based on the decrypted image data (S406). The output process at step S406 is an output such as image forming onto a image forming media and facsimile transmission of the image data based on various functions of the digital multifunctional product.

At step S403, when the accepted authentication information matches the authentication information which is set to the image data (S403: NO), following steps are not performed, a message that the authentication information is incorrect or the like is output, and the process is terminated. The image data after the output process is nullified as needed based on an operation by the operator.

The above-mentioned detailed description of the present invention is partly exemplified and illustrated out of possible embodiments of this invention, and this invention is not limited by the description.

1-5. (canceled)

6. An image processing apparatus including a storing meansunit for storing image data and performing an output process based on the image data stored in the storing meansunit, comprising a controller including:
means for designating the image data stored in the storing meansunit,
and accepting an instruction for concealment of the designated image data,
means for concealing the designated image data based on the accepted instruction, and
means for nullifying unconcealed image data.

7. The image processing apparatus according to claim 6, wherein the controller further comprises:
means for detecting whether or not a processing meansunit for processing the image data is provided and an operation state thereof, and
means for determining a concealing method based on detected results.

8. An image processing apparatus including a storing meansunit for storing image data and performing an output operation based on the image data stored in the storing meansunit, comprising a controller including:
means for designating the image data stored in the storing meansunit,
and accepting an instruction for concealment of the designated image data,
means for detecting whether or not a processing meansunit for processing the image data is provided and an operation state thereof,
means for determining a concealing method based on detected results, and
means for concealing the designated image data by means of the determined method based on the accepted instruction.

9. The image processing apparatus according to claim 8, wherein
the concealing method is encrypting the image data, and
the controller includes
means for decoding encrypted image data in the case of performing an output operation based on the image data.

10. The image processing apparatus according to claim 7, wherein
the concealing method is setting of authentication information encrypting to the image data,
the controller further comprises:
means for accepting authentication information;
means for verifying the authentication information set to the image data with the accepted authentication information; and
means for permitting the output process of the image data in the case where the authentication information set to the image data matches the accepted authentication information, and
the controller decodes encrypted image data in the case of performing an output operation based on the image data.

11. The image processing apparatus according to claim 8, wherein
the concealing method is encrypting the image data, and
the controller
decodes encrypted image data in the case of performing an output operation based on the image data.

12. The image processing apparatus according to claim 6, wherein
a concealing method is setting of authentication information to the image data, and
the controller
accepts authentication information,
verifies the authentication information set to the image data with the accepted authentication information, and
permits the output process of the image data in the case where the authentication information set to the image data matches the accepted authentication information.

13. The image processing apparatus according to claim 7, wherein
the concealing method is setting of authentication information to the image data, and
the controller
accepts authentication information,
verifies the authentication information set to the image data with the accepted authentication information, and
permits the output process of the image data in the case where the authentication information set to the image data matches the accepted authentication information.

14. The image processing apparatus according to claim 8, wherein
the concealing method is setting of authentication information to the image data, and
the controller
accepts authentication information,
verifies the authentication information set to the image data with the accepted authentication information, and
permits the output process of the image data in the case where the authentication information set to the image data matches the accepted authentication information.

15. The image processing apparatus according to claim 9, wherein
the concealing method is setting of authentication information to the image data, and
the controller
accepts authentication information,
verifies the authentication information set to the image data with the accepted authentication information, and
permits the output process of the image data in the case where the authentication information set to the image data matches the accepted authentication information.

16. The image processing apparatus according to claim 10, wherein
concealing method is setting of authentication information to the image data, and
the controller
accepts authentication information,
verifies the authentication information set to the image data with the accepted authentication information, and
permits the output process of the image data in the case where the authentication information set to the image data matches the accepted authentication information.

17. The image processing apparatus according to claim 11, wherein
the concealing method is setting of authentication information to the image data, and
the controller
accepts authentication information,
verifies the authentication information set to the image data with the accepted authentication information, and
permits the output process of the image data in the case where the authentication information set to the image data matches the accepted authentication information.
